(19) United States
(12) Patent Application Publication
(10) Pub. No.: US 2026/0336006 A1
(43) Pub. Date: Oct. 29, 2026

(54) Additive Manufacturing Modular End Effector Assembly

(71) Applicant: Relativity Space, Inc., Long Beach, CA (US)

(72) Inventors: Jeffrey Campbell, Long Beach, CA (US); Fritz Gruber, Long Beach, CA (US); Edward Cottiss, Long Beach, CA (US); Jasmine Moreno, Long Beach, CA (US); Jeremy Krol, Long Beach, CA (US); Justin Gray, Long Beach, CA (US); Nathaniel Hebert, Long Beach, CA (US); Johann Freeberg, Long Beach, CA (US); Bryan Watson, Long Beach, CA (US)

(73) Assignee: Relativity Space, Inc., Long Beach, CA (US)

(21) Appl. No.: 19/120,188

(22) PCT Filed: Oct. 10, 2023
(86) PCT No.: PCT/US2023/076486

§ 371 Date: Apr. 10, 2025

(51) Int. Cl. B23K 9/095; B23K 9/04; B33Y 30/00; B33Y 50/02

(52) U.S. Cl. CPC B23K 9/0953; B23K 9/04; B23K 9/0956; B33Y 30/00; B33Y 50/02

(57) ABSTRACT

A device may include a robotic actuator. A device may include an end effector assembly mounted to the robotic actuator, the end effector assembly comprising: a modular interface, the modular interface comprising a set of connection points, the set of connection points arranged circumferentially about a modular interface central axis, a hot wire torch, the hot wire torch coupled to the modular interface, the hot wire torch comprising a hot wire torch endpoint; and one or more sensors fixedly attached via the connection points to the modular interface, wherein the one or more sensors are positioned to generate data based on observations of an observation position, the observation position offset relative to the hot wire torch endpoint.

### CROSS-REFERENCE TO RELATED APPLICATIONS

The current application claims priority to U.S. Provisional Patent Application No. 63/378,975 filed Oct. 10, 2022 titled “Additive Manufacturing Modular End Effector Assembly,” U.S. Provisional Patent Application No. 63/488,435 filed Mar. 3, 2023 titled “Additive Manufacturing Modular End Effector Assembly,” and U.S. Provisional Patent Application No. 63/493,683 filed Mar. 31, 2023, the disclosures of which are incorporated herein by reference in their entireties for all purposes.

### FIELD OF THE INVENTION

The present invention generally related to robotic wire arc additive manufacturing (WAAM) systems.

### BACKGROUND

Additive manufacturing is a process by which a product or part is manufactured by adding one layer of material on top of another in a sequence or pattern that would result in a solid part being built. This method of manufacturing is commonly referred to as three dimensional or 3-D printing and can be done with different materials, including plastic and metal. Wire arc additive manufacturing (WAAM) is a production process used to 3D print and/or repair metal parts using a metal wire feedstock and an electric arc as an energy source.

WAAM typically involves using an energy source to create a weld pool and feeding a metal wire (feed material) into the weld pool by way of a printing head or printing head nozzle. Energy (namely, an electric current carried by the feed wire) is used to create the weld pool. The printing head, and subsequently the weld pool can be moved. As the printing head and the welding pool moves, the trailing edge of the pool cools and solidifies. Through this process of gradually moving the printing head along a path can lead to a fully printed part.

The process by which material is deposited can be controlled by the use of shielding gas around the feeding material. The shielding gas can help to make a better weld pool for an overall better part. The shielding gas can protect the weld pool from corrosive gases and moisture.

### SUMMARY OF THE INVENTION

In some embodiments, a device can be configured to increase precision in additive manufacturing processes. In an embodiment, the device includes a robotic actuator, and an end effector assembly. The end effector assembly includes a modular interface. The modular interface includes a set of connection points. The set of connection points arranged circumferentially about a modular interface central axis. The modular interface further includes a clamping apparatus centrally located with respect to the set of connection points, and a hot wire torch. The hot wire torch attached via the clamping apparatus to the modular interface. The clamping apparatus applying a clamping force to the hot wire torch along a plane approximately perpendicular to a hot wire torch axis. The hot wire torch including a hot wire torch endpoint; and a hot wire torch base unit. The end effector assembly further includes one or more sensors fixedly attached via the connection points to the modular interface. The one or more sensors are positioned to generate data based on observations of an observation position. The observation position offset relative to the hot wire torch endpoint. The end effector assembly further including a cold wire assembly. the cold wire assembly attached via the connection points to the modular interface, a cold wire torch axis configured to intersect the hotwire torch axis at the hot wire torch endpoint. The cold wire assembly including a cold wire actuator movably attached to the cold wire assembly, a cold wire endpoint, and a cold wire base unit. The movable attachment configured to modify the relative position of the cold wire endpoint to the hot wire torch endpoint. The end effector assembly further including a mounting assembly. The mounting assembly including a base plate. The base plate mounting the cold wire base unit and the hot wire torch base unit and the baseplate rigidly attached to the robotic actuator. The mounting assembly further includes one or more riser plates fixedly mounted to the base plate and extending perpendicularly from the base plate. The riser plates are fixedly attached to the modular interface such that the connection plane is perpendicular to a base plate plane defined by the base plate. The end effector assembly further including a localized fume extraction assembly. The localized fume extraction assembly including a rail fixedly mounted to the one or more riser plates. The rail arranged parallel to the base plate. The localized fume extraction assembly further including a fume hood, and a positioning arm. The positioning arm configured to translate along the rail, the translation in a direction perpendicular to the connection plane, and the positioning arm connected at a terminal end to the fume hood. The end effector assembly further including a control assembly. The control assembly including memory, and a processor. The processor configured to receive sensor data generated by the one or more sensors, generate a profile. The profile generated based on the offset associated with the observation position, and based on the sensor data. The processor further configured to determine a center of a part, determine an x-offset. The x-offset determined based on the profile, the center of the part and the sensor data. The processor further configured to cause the robotic actuator to move the hot wire torch endpoint to a new position based on the x-offset.

In a further embodiment, the positioning arm is connected at a terminal end to the fume hood by a socket joint.

In another embodiment, the hot wire torch endpoint is located centrally relative to the set of connection points.

In a yet further embodiment, the clamping apparatus comprises fiberglass-epoxy laminate.

In a still further embodiment, the clamping apparatus electrically insulates the hot wire torch from the modular interface.

In a still yet further embodiment, the clamping apparatus can comprise a v-cut jog.

In a yet still further embodiment, the hot wire is clamped nearer the modular central interface axis as compared to the set of connection points.

In a yet further embodiment again, the clamping plane is parallel to and spaced apart from the connection plane.

In a still further embodiment again, the one or more sensors each have a type selected from a list including welding cameras, infrared cameras, visible light camera, laser sensors.

In an additional further embodiment, the one or more sensors comprise a welding camera mounted to the modular interface at a 12 o'clock position.

In an additional further embodiment again, the one or more sensors comprise a welding camera mounted to the modular interface at a 6 o'clock position.

In a still additional further embodiment, the one or more sensors comprise a laser sensor mounted to the modular interface at a 2 o'clock position.

In an additional yet further embodiment, the one or more sensors comprise a laser sensor mounted to the modular interface at a 10 o'clock position.

In a still additional further embodiment again, the one or more sensors comprise a visible light camera mounted to the modular interface at an 8 o'clock position.

In an additional yet further embodiment again, attaching via connection points comprises fixedly attaching via connection points.

In a yet still further embodiment again, the cold wire assembly is connected via two connection points.

In yet another embodiment, the cold wire assembly is connected via a first connection point to the modular interface at a 11 o'clock position, and the cold wire assembly is connection via a second connection point to the modular interface at a 1 o'clock position.

In still another embodiment, the one or more sensors comprise a sensor positioned to observe a point on a workpiece, the point offset from the hotwire torch endpoint.

In still yet another embodiment, the one or more sensors comprise a sensor positioned to observe a point on a workpiece, the point offset from the hotwire torch endpoint by about 2 inches.

In yet still another embodiment, the one or more sensors comprise a sensor positioned to observe a point on a workpiece, the point offset from the hotwire torch endpoint by about 2.1 inches.

In yet another embodiment again, a cold wire can be rotated relative to the hot wire torch by 3 degrees.

In still another embodiment again, the set of connection points comprises 12 connection points.

In yet still another embodiment again, the one or more sensors comprise a welding camera mounted to a first connection point, and the first connection point is located between a second connection point and a third connection point wherein the second connection point and third connection point mount a cold wire assembly.

In still yet another embodiment again, the one or more sensors comprise a welding camera mounted such that the cold wire assembly and the welding camera share a plane of symmetry.

In another further embodiment, the one or more riser plates comprise two riser plates.

In still another further embodiment, the one or more riser plates comprise a first riser plates and a second riser plate, the first riser plate and second riser plate parallel and spaced apart from each other.

In yet another further embodiment, the one or more riser plates comprise a first riser plates and a second riser plate, the first riser plate and second riser plate spaced apart and the hot wire torch extending through the space between the first riser plate and the second riser plate.

In still yet another further embodiment, the localized fume extraction assembly further includes a second fume hood.

In yet still another further embodiment, the fume hood comprises a flattened front portion.

In still another further embodiment again, the fume hood comprises a shield mounted on a flattened front portion.

In yet another further embodiment again, the positioning arm include 4 links connected by joints.

In another further embodiment again, the positioning arm includes one or more ball joints.

In an additional further embodiment, the localized fume extraction assembly further includes a second positioning arm.

In an additional further embodiment again, determining an x-offset is further based on a received simulation.

In several embodiments, a device can be configured to increase precision in additive manufacturing processes. In an embodiment, the device includes a modular interface. The modular interface including a set of connection points. The set of connection points arranged circumferentially about a modular interface central axis. The set of connection points configured to fixedly mount one or more sensors. The modular interface further including a clamping apparatus centrally located with respect to the set of connection points. The clamping apparatus is configured to fixedly mount an additive manufacturing applicator.

In an additional embodiment, the clamping apparatus is configured to allow a hot wire torch endpoint to be centrally mounted relative to the set of connection points.

In a yet additional embodiment, the clamping apparatus comprises fiberglass-epoxy laminate.

In a still additional embodiment, the clamping apparatus electrically insulates the hot wire torch from the modular interface.

In a still yet additional embodiment, the clamping apparatus can comprise a v-cut jig.

In a yet still additional embodiment, the set of connection points is further configured to mount a tool actuator.

In an additional embodiment again, the clamping apparatus comprises a centrally located through-hole.

In a yet additional embodiment again, the device further includes a hot wire torch fixedly mounted to the modular interface via the clamping apparatus, the hot wire torch comprising a hot wire torch endpoint, and a hot wire torch longitudinal axis.

In a still additional embodiment again, the clamping apparatus includes a clamping point. The clamping point offset and parallel from a connection point plane. The connection point plane intersecting the set of connection points.

In various embodiments, a device can be configured to locally extract fumes generated in an additive manufacturing process. In an embodiment, the device includes a localized fume extraction assembly. The localized fume extraction assembly including a rail fixedly mounted to one or more riser plates. The rail arranged parallel to a base plate. The device further including a fume hood, and a positioning arm. The positioning arm configured to translate along the rail, and the positioning arm connected at a terminal end to the fume hood. The positioning arm including one or more joints and links.

In some further embodiment, the device further includes an arc protection assembly.

In still some further embodiment, the device further includes an arc protection assembly, the arc protection assembly including a bracket slidably mounted to the rail; and a shield fixedly mounted to the bracket.

In yet some further embodiment, the positioning arm is mounted to a cross bar.

In some further embodiment again, the localized fume extraction assembly further comprises a cross bar, wherein the positioning arm is attached using a joint to one end of the crossbar and a second positioning arm is attached using a second joint at a second end of the crossbar.

In an additional some further embodiment, the localized fume extraction assembly is fixedly coupled to an additive manufacturing end effector.

In yet some further embodiment again, the localized fume extraction assembly further includes a second fume hood.

In still some further embodiment again, the fume hood comprises a flattened front portion.

In an additional some further embodiment again, the fume hood comprises a shield mounted on a flattened front portion.

In yet still some further embodiment, the positioning arm include 4 links connected by joints.

In still yet some further embodiment, the positioning arm includes one or more ball joints.

In still yet some further embodiment again, the localized fume extraction assembly further includes a second positioning arm.

In numerous embodiments, a device can be configured to attach and actuate an additive manufacturing implement. In an embodiment, the device includes an actuator. The actuator movably attached to a driving motor, a frame, and an implement mount. The driving motor is configured to drive the actuator. The frame is fixedly mounted to the driving motor. The frame includes a connection point configured to attach the actuator to an interface. The actuator configured to adjust a position of an endpoint of an additive manufacturing applicator. The position is adjusted by using the driving motor to drive a mechanical linkage.

In another additional embodiment, the frame further comprises a second connection point.

In still another additional embodiment, the frame further comprises a second connection point and the actuator can be configured to allow a sensor to be mounted to the interface between the first and second connection points.

In yet another additional embodiment, the frame further comprises the first connection point and a second connection point are at a first end portion of a first arm, and a second end portion of a second arm.

In still another additional embodiment again, the mechanical linkage is a 4-bar linkage.

In yet another additional embodiment again, the mechanical linkage is configured to enable an axis of the endpoint of the additive manufacturing applicator to rotate by 3 degrees relative to an axis of an endpoint of a second additive manufacturing applicator.

In still yet another additional embodiment, the additive manufacturing applicator is a cold wire.

In yet still another additional embodiment, the second additive manufacturing applicator is a hot wire torch.

In numerous embodiments, a device can be configured to perform an additive manufacturing process. In an embodiment, the device includes a robotic actuator, and an interface mounted to an end of the robotic actuator. The interface including a clamping point, and first through seventh connection points. The first through seventh connection points are arranged sequentially by number, and circumferentially around a central axis. The clamping point is located centrally with respect to the first through seventh connection points. The device further including a first sensor fixedly mounted to the first connection point, a second sensor fixedly mounted to the second connection point, a third sensor fixedly mounted to the third connection point, a fourth sensor fixedly mounted to the fourth connection point, a fifth sensor fixedly mounted to the sixth connection point. The device further including an additive manufacturing applicator, the additive manufacturing applicator including a first part and a second part. The first part is fixedly mounted to the fifth and seventh connection points. The second part is movably coupled to the first part and is capable of changing a relative position of an endpoint of the additive manufacturing applicator with respect to the modular interface.

In yet still another additional embodiment again, the fifth sensor is a welding camera.

In still yet another additional embodiment again, the fourth sensor is a laser sensor.

In a further additional embodiment, the third sensor is a visible light camera.

In a yet further additional embodiment, the second sensor is a welding camera.

In a still further additional embodiment, the first sensor is a laser sensor.

In a further additional embodiment again, the fifth sensor is located at a 12 o'clock position.

In a yet further additional embodiment again, the fourth sensor is located at a 10 o'clock position.

In a still further additional embodiment again, the third sensor is located at an 8 o'clock position.

In a still yet further additional embodiment, the second sensor is located at a 6 o'clock position.

In a yet still further additional embodiment, the first sensor is located at a 2 o'clock position.

In a still yet further additional embodiment again, the additive manufacturing applicator is a cold wire.

In a yet still further additional embodiment again, the first part is fixedly mounted at a 11 o'clock position and a 12 o'clock position.

In some further additional embodiment, the fifth sensor is positioned between a first connection point and a second connection point on the additive manufacturing applicator.

In some further additional embodiment again, the interface is a modular interface.

In many embodiments, a device can be configured to send commands to a robot to position the robot with respect to a workpiece. In an embodiment, the device includes a robotic actuator, memory, and a processor. The processor configured to receive sensor data generated by one or more sensors, and generate a profile. The profile generated based on the sensor data. The processor further configured to determine a center of a part, and determine an x-offset. The x-offset determined based on the profile, the center of the part and the sensor data. The processor further configured to cause the robotic actuator to move the hot wire torch endpoint to a new position based on the x-offset.

In an even further embodiment, the one or more sensors include a laser sensor.

In a still even further embodiment, determining an x-offset is further based on a received simulation.

In a yet even further embodiment, the processor causes the robotic actuator to move while an additive manufacturing applicator associated with the robotic actuator is off.

In a still even further embodiment again, the processor causes the robotic actuator to move while an additive manufacturing applicator associated with the robotic actuator is active.

In a yet even further embodiment again, generating a profile comprises filtering a raw profile, the raw profile based on the sensor data.

In a still yet even further embodiment, filtering a profile comprises filtering any values that are outside of a laser sensor accuracy bound.

In a still yet even further embodiment again, filtering a profile comprises remove outliers by computing a delta around each point and when the delta exceeds a threshold, the point can be removed.

In another even further embodiment, the processor can be further configured to receive hot wire torch endpoint location data, and wherein causing the robotic actuator to move the hot wire torch endpoint to a new position is further based on hot wire torch endpoint location data.

In some embodiments, the techniques described herein relate to a device configured to perform additive manufacturing processes. In an embodiment, the device includes: a robotic actuator; and an end effector assembly mounted to the robotic actuator, the end effector assembly including: a modular interface, the modular interface including a set of connection points, the set of connection points arranged circumferentially about a modular interface central axis; a hot wire torch, the hot wire torch coupled to the modular interface, the hot wire torch including a hot wire torch endpoint; and one or more sensors fixedly attached via the set of connection points to the modular interface, wherein the one or more sensors are positioned to generate data based on observations of an observation position, wherein the observation position is offset relative to the hot wire torch endpoint.

In a yet even further embodiment again, the hot wire torch is attached via a clamping apparatus that is centrally located with respect to the set of connection points, the clamping apparatus applying a clamping force to the hot wire torch along a plane approximately perpendicular to a hot wire torch axis.

In another embodiment, a device can further include a cold wire assembly attached via the set of connection points to the modular interface.

In another embodiment again, the device can further include a localized fume extraction assembly, the localized fume extraction assembly fixedly mounted to the robotic actuator and the localized fume extraction assembly including: a fume hood; and a positioning arm, the positioning arm including a proximal end coupled to the robotic actuator and a terminal end coupled to the fume hood.

In another further embodiment again, a first end of the positioning arm is capable of translating along a rail, the rail coupled to the robotic actuator.

In another yet further embodiment again, the fume hood includes a flattened front portion.

In another yet even further embodiment again, the fume hood includes a shield mounted on a flattened front portion.

In a yet further embodiment, the positioning arm includes 4 links connected by joints.

In a yet further embodiment again, the device can further include a control assembly, the control assembly including: memory; and a processor, the processor configured to: receive sensor data generated by the one or more sensors; generate a profile, the profile generated based on the offset associated with the observation position, and based on the sensor data; determine a center of a part; determine an x-offset based on the profile, the center of the part and the sensor data; and cause the robotic actuator to move the hot wire torch endpoint to a new position based on the x-offset.

In a yet even further embodiment again, the hot wire torch endpoint is located centrally relative to the set of connection points.

In another yet even further embodiment again, the one or more sensors each have a type selected from a list including welding cameras, infrared cameras, visible light camera, laser sensors.

In a still yet further embodiment, a wire arc additive manufacturing nozzle is mounted to the modular interface by at least one connection point.

In a still yet further embodiment again, the observation position is offset from the hot wire torch endpoint by about 2 inches.

In another still yet further embodiment, the observation position is offset from the hot wire torch endpoint by about 2.1 inches.

In another still yet further embodiment again, the set of connection points includes 12 connection points.

In several embodiments, a device is configured to perform additive manufacturing processes. In an embodiment, the device includes: a robotic actuator; an end effector assembly mounted to the robotic actuator, the end effector assembly including: an interface; and a hot wire torch, the hot wire torch coupled to the interface, the hot wire torch including a hot wire torch endpoint; and one or more sensors fixedly attached to the interface, wherein the one or more sensors are positioned to generate data based on observations of an observation position, wherein the observation position is offset relative to the hot wire torch endpoint.

In another still yet even further embodiment again, the observation position is offset from the hot wire torch endpoint by about 2 inches.

In still yet even further embodiment again, the device further includes a control assembly, the control assembly including: memory; and a processor, the processor configured to: receive sensor data generated by the one or more sensors; generate a profile, the profile generated based on the offset associated with the observation position, and based on the sensor data; determine a center of a part; determine an x-offset based on the profile, the center of the part and the sensor data; and cause the robotic actuator to move the hot wire torch endpoint to a new position based on the x-offset.

In numerous embodiments, a device is configured to increase precision in additive manufacturing processes. In an embodiment, the device including: a modular interface, the modular interface including: a set of connection points, the set of connection points arranged circumferentially about a modular interface central axis, the set of connection points configured to fixedly mount one or more sensors; and a clamping apparatus centrally located with respect to the set of connection points, wherein the clamping apparatus is configured to fixedly mount an additive manufacturing applicator.

In still yet another even further embodiment again, the additive manufacturing applicator includes a hot wire torch.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A through 1C conceptually illustrate an additive manufacturing end-effector assembly.

FIG. 2 conceptually illustrates an example modular interface.

FIG. 3 conceptually illustrates an example modular interface with a mounted applicator actuator.

FIG. 4 conceptually illustrates an example end-effector including an additive manufacturing applicator that is fixedly and centrally mounted to a modular interface.

FIG. 5 conceptually illustrates an example modular interface with a centrally mounted additive manufacturing applicator.

FIG. 6 conceptually illustrates an example configuration for a modular interface.

FIG. 7 conceptually illustrates an example of a localized fume extractor.

FIG. 8 conceptually illustrates an example of an arc protection assembly.

FIG. 9 conceptually illustrates an example process for generated a profile for a part during a welding based additive manufacturing process.

FIG. 10 conceptually illustrates an example process for commanding a robot to assume a new position based on a determined x-offset.

FIG. 11 conceptually illustrates a location of a laser scan relative to an additive manufacturing nozzle.

FIG. 12 conceptually illustrates an additive manufacturing end-effector assembly configured to mount to a robotic actuator.

FIG. 13 conceptually illustrates an example computer system.

FIG. 14 conceptually illustrates a controller block diagram of an automated contact tip to work piece correction process.

FIG. 15 conceptually illustrates an example WAAM nozzle assembly mounted to an end effector assembly.

### DETAILED DESCRIPTION

In robotic manufacturing, an end effector can be a device mounted to the end of the robotic arm designed to interact with the environment and perform manufacturing operations. The end effector may also be referred to as end of arm tooling (“EOAT”).

In several embodiments, an additive manufacturing end effector is configured to achieve improvements to speed, accuracy, precision, and part size in Wire Arc Additive Manufacturing (WAAM) processes. A modular interface can be included in the end effector in various embodiments. A modular interface can be a mechanical interface (mechanical interfaces are also referred to herein as “interfaces”) that can enable attachment and detachment of integrated electronics, sensors infrared and visible light cameras, laser profile sensors, support for multiple hot and cold weld wires, multi-axis positioning of cold wire or wires, local arc shielding for human observation, and localized fume extraction.

In accordance with several embodiments of the invention, an end effector assembly can be located closer to the weld pool than previous end effectors to increase system rigidity and reduce relative movement between the sensing hardware, additive manufacturing applicators (e.g., a hot wire torch), and weld pool. This increase in rigidity and reduction in relative movement can improve accuracy and precision of 3D printed products which can allow production of more complicated geometries with increased throughput. Various embodiments increase the accuracy of the measurements taken during the print process, thereby mitigating print deviations and reducing operation stoppages to further increase print speed.

Modular interfaces, in a number of embodiments, are configured to enable repositioning of sensors to the optimal position based on the robot's reach limitations, movement requirements, and print cell boundaries. The modular interface can particularly beneficial for horizontal printing applications involving multiple manufacturing robots.

In some embodiments, tool actuators with cold wire additive manufacturing applicators can have two-axis control of one or more cold wires. This can enable quick manipulation during manufacturing (e.g., weld) processes to adjust wire contact area, manipulation of the wire to achieve certain wetting actions, manipulation of the wire to shape the weld pool, and/or control of the feed rate to increase print speed. The tool actuator provides more control of the weld pool overall. In several embodiments, dragging a cold wire along base weld before entering the weld pool can produce different wetting action in comparison to going straight into the weld pool; tool actuators can control this quickly during a WAAM process to enable improved control of the welding process. In various embodiments, two axis control of a cold wire can enable the robotic welder to have greater control.

Integrated sensors (e.g., cameras and laser position sensors) can, in some embodiments, allow end effectors to perform restarts. Restarts can include the end effector automatically aligning itself to an x-axis. Automation of restarts can allow a start or restart of an operation without human input and can thereby further increase production speed by reducing downtime from restarts. In several embodiments, dynamic restarts can be performed dynamically while a manufacturing operation is in process. Dynamic restarts can improve production accuracy.

Typically fume extraction and arc shielding are performed by separate systems from the end effector. The fume extraction systems are bulky and present a barrier to increased production speed and part size in horizontal WAAM processes. Arc shielding is typically limited to rudimentary panels or interfaces which must be moved as a WAAM product grows in a horizontal print orientation or if the robot is repositioned. In accordance with numerous embodiments of the invention, localized arc shielding and/or fume extraction can be fixedly coupled relative an additive manufacturing applicator. This can increase production speed by removing the need to reposition fume extraction or arc protection systems. In several embodiments a fume extractor and/or an arc protection assembly can be attached to the end effector an additive manufacturing robot. By containing shielding and fume extraction to the end effector itself, the need for human intervention to relocate the fume extraction and arc shielding systems can be eliminated. Localized arc shielding can allow humans to be proximate to a robot that is performing WAAM without specialized equipment or necessitating a production stoppage. Achieving localized arc shielding and fume extraction required experimentally solving problems involving interaction of fume system suction and weld purge gas supply. Investigations involved several iterations of arc shield gap sizing and experiments with flexible and rigid shields to achieve a system that did not interfere with purge gas flow or block line of sight while also adequately removing weld fumes.

In various embodiments, devices and processes can be used with WAAM. An additive manufacturing applicator in a WAAM system can be a hot wire torch or a cold wire. A hot wire torch can have a base unit, a longitudinal axis and an endpoint. A cold wire can have an endpoint and a base unit.

Throughout this document the term fixedly can be used to denote rigid attachment (e.g., no relative motion) during operation. Fixedly attached can refer to a condition where parts are connected so as to prevent relative motion during operation and fixedly can include when those parts can simultaneously be removable.

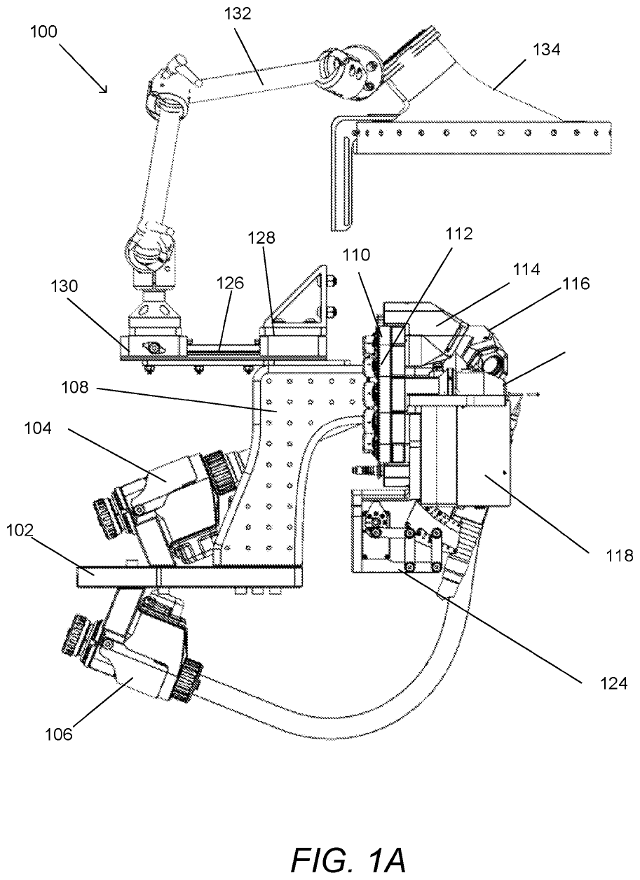

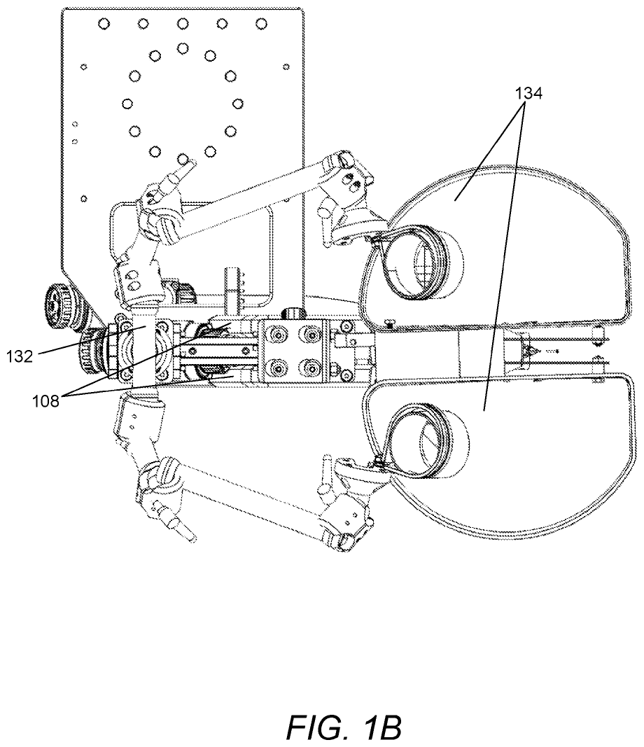

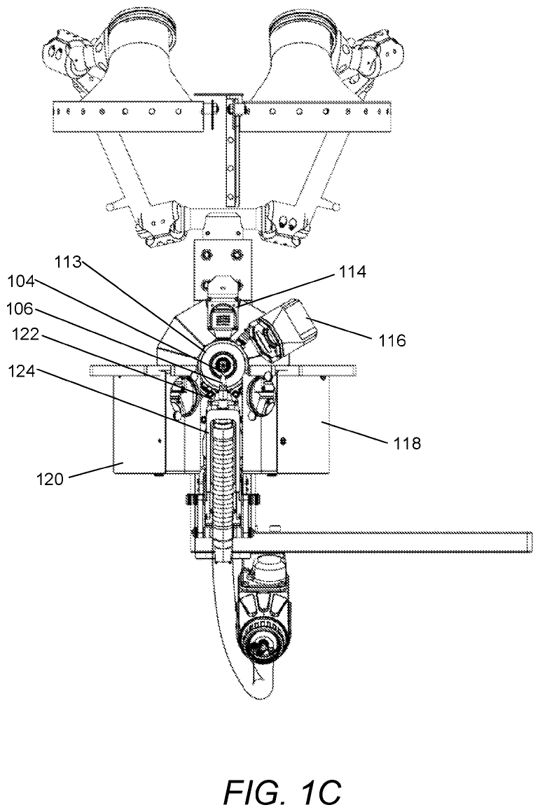

Additive manufacturing devices can utilize an end-effector assembly mounted to a robotic actuator. An additive manufacturing end-effector assembly is conceptually illustrated in FIG. 1. The assembly 100 can include a base plate 102. The base plate 102 can be fixedly coupled, to a first additive manufacturing applicator 104 (e.g., a hot wire torch) at a base of the first additive manufacturing applicator. The base plate 102 can be fixedly coupled to a second additive manufacturing applicator 106 (e.g., a cold wire applicator) at a base of the second additive manufacturing applicator. A riser plate 108 can extend perpendicularly from the base plate 102. The riser plate 108 can be fixedly coupled to the base plate 102. Two riser plates 108 can extend perpendicularly from the base plate 102. In various embodiments, the base plate can be configured to connect to a robotic actuator. In many embodiments, the base plate base plate 102 can be a mount for electronics. An interface plate 110 (e.g., a modular interface) can be mounted (e.g., fixedly) to the riser plate(s) 108.

The interface 110 can include a set of connection points 112. The set of connection point 112 can be arranged circumferentially around a central axis. The connection points making up the set of connection points 112 can all lie on a plane; the plane can be referred to as a connection plane. The connections points can all lie along the circumference of a connection circle on the connection plane. The interface 110 can include a clamping point 113 that can be centrally located with respect to the set of connection points 112. In various embodiments, a set of connection points can include twelve connection points. In some embodiments, each of the connection points can be configured to fixedly mount equipment. Connection point mountable equipment can include (but is not limited to) sensors, additive manufacturing applicators, and/or other equipment. In the depicted example, the interface 110 is fixedly coupled to a first sensor 114, a second sensor 116, a third sensor 118, a fourth sensor 120, and a fifth sensor 122. In various embodiments each of the first through fifth sensors can be included or omitted. Each of the sensors can have a sensor type. Sensor types can include laser sensors, welding cameras, infrared cameras, and/or visible light cameras. In some embodiments, the first sensor 114 can be a welding camera, the second sensor 116 can be a visible light camera, the third sensor 118 can be a laser sensor, the fourth sensor 120 can be a laser sensor, and the fifth sensor 122 can be a welding camera. The first additive manufacturing applicator (e.g., a hot wire torch for a WAAM system) 104 can be fixedly coupled (e.g., clamped) at the clamping point 113. The clamping point can attach near a terminal end of the additive manufacturing applicator 104. Fixedly coupling both the first manufacturing additive applicator and sensors to the modular interface can reduce relative motion between the sensors (e.g., sensors 114, 116, 118, 120, and/or 122) and the applicator (e.g., applicator 104) to improve additive manufacturing accuracy. The second additive manufacturing applicator 106 can be mounted on an applicator actuator 124. The applicator actuator 124 can have a frame and an actuation mechanism. The frame can be fixedly mounted to the modular interface 110 using the set of connection points 112. In various embodiments, applicator actuators can be mounted using 1, 2, 3 or another number of connection points. In the depicted example, the applicator actuator 124 can be mounted using two connection points. The sensor 122 can be mounted to a connection point positioned between the two connection points used to mount the applicator actuator 124.

A rail 126 can be fixedly coupled to the riser plates 108. The rail can lie on a plane parallel and offset by a plane defined by the base plate 102. The rail 126 can extend linearly towards the modular interface 110. A shield holder 128 can be slidably coupled to the rail 126. Shield holders can be configured to hold and position shields near and around the position of interest (e.g., the site of additive manufacturing deposition, a weld pool). The shield holder 128 can be linearly translated along the rail 126. A fume extractor base 130 can be slidably coupled to the rail 126. The fume extractor base 130 can be movably attached to a fume extractor positioning arm assembly 132. At a terminal end of the fume extractor positioning arm assembly, fume hoods 134 are positionably attached. In various embodiments, localized fume extraction can more energy efficient than whole room fume extraction.

### Modular Interface

Various embodiments include features to reduce the size of the modular interface plate. Reducing the size of the interface plate is valuable to enable an additive manufacturing device to print a greater variety of parts. Reducing the size of the interface plate (and other parts) can render the additive manufacturing end effector more maneuverable due to having a smaller size and/or weight. Various embodiments utilize geometric, component, configuration, and/or position selections to reduce component size and/or weight.

Many embodiments include connection points arranged around a central axis. These connection points can share a universal connection. Using a universal connection means can enable attachable components (e.g., sensors, and/or additive manufacturing applicators) to be rearranged. In accordance with a number of embodiments, a circular arrangement of connection points enables consistent spacing restrictions between attached components since each of the connection points has a set similar relative positions versus the other connection points as compared to each of the other connection points.

In several embodiments the components attached to an interface plate can be rigidly attached. The equipment attached can be sensors and additive manufacturing applicators. Rigidly attaching both the sensors and the additive manufacturing applicators to the same rigid body (and in close proximity) advantageously reduces the relative motion between the sensors and/or the additive manufacturing applicators. Reducing the relative motion between the sensors and/or the additive manufacturing applicators can reduce uncertainty in sensor data associated with changes (e.g., slight changes) in position between the various sensors and/or additive manufacturing applicators.

While specific processes and/or systems for an additive manufacturing end-effector assembly are described above, any of a variety of processes and/or systems can be utilized as an additive manufacturing end-effector assembly as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to an additive manufacturing end-effector assembly, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

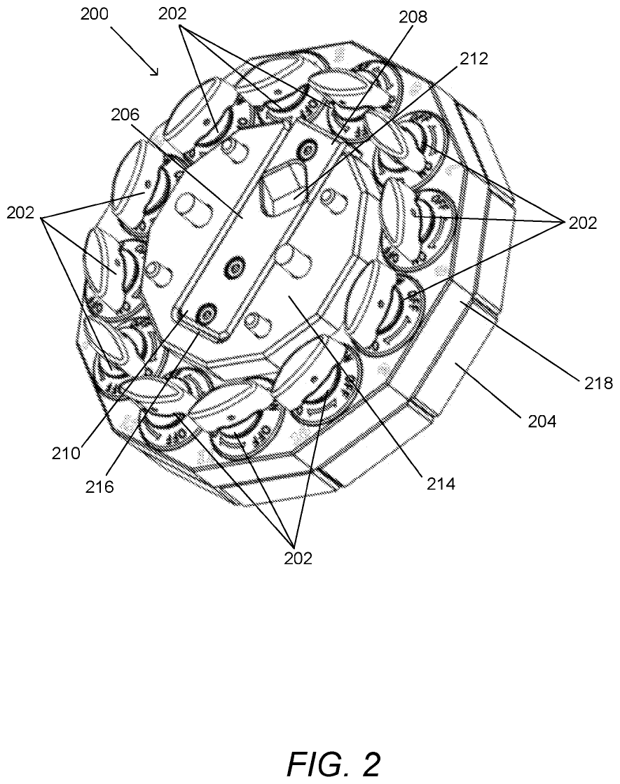

In several embodiments, an end-effector assembly mounted to a robotic actuator can include a modular interface. The modular interface can be configured to interchangeably mount equipment. Mountable equipment can include (but is not limited to) sensors and/or additive manufacturing applicators. An example modular interface is conceptually illustrated in FIG. 2. The modular interface assembly 200 can include twelve connection points 202. Each connection point 202 can be connected to a protective cover block 204, or to equipment (e.g., equipment including, but not limited to actuators, sensors, and/or nozzle assemblies). The twelve connection points 202 form a set of connection points. The connections points 202 can be coplanar with each other, and lie on a connection plane. Each of the connection points 202 lie along a circumference on the connection plane. A clamping apparatus 206 can be centrally located with respect to the connection points 202. In several embodiments, a clamping apparatus can apply a clamping force to a hot wire torch. Such a clamping force can be applied along a plane approximately perpendicular to the hot wire torch axis. The clamping apparatus 206 can include a first block 208 and a second block 210. Between the first block 208 and the second block 210 can be a through hole 212. The perimeter of the first block 208 and the second block 210 can be a rectangular shape. An attachment plate 214 can be centrally located with respect to the connection points 202. The attachment plate 214 can be generally dodecagonal and can include a slot 216. The slot 216 can be rectangular. The first block 208 and second block 210 can be positioned (e.g., inset) in the slot 216. The attachment plate 214 can have mechanical fasteners disposed on its surface. The attachment plate 214 can be configured to attach to riser plates (e.g., riser plates 108). The attachment plate 214 can include a central plate 218. In accordance with many embodiments, an attachment plate (e.g., attachment plate 214) and a central plate (e.g., central plate 218) can be a single machined component. The central plate 218 can be a polygon (e.g., a regular dodecagon). Each side of the dodecagon can be parallel with a line defined as tangential to the circle defined by the set of the connection points.

The central plate 218 can be polygonal (e.g., a regular dodecagon). The central plate 218 can have an edge parallel with and offset from a line intersecting a connection point and tangential to a circle defined by connection points 202. The attachment plate 214 can be polygonal (e.g., a regular dodecagon) except for the slot 216. The attachment plate 214 can be geometrically similar (except for the slot 216), to the central plate 218. The sides of the polygon associated with the attachment plate 214 can be parallel to the sides of the polygon associated with the central plate 218. An end surface of the first block 208 can be parallel to a side of the polygon associated with the central plate 218. In various embodiments the attachment plate could be a polygonal shape around the outside edge.

The through hole 212 is inside a clamping point. At the clamping point the additive manufacturing applicator can be fixedly attached to the interface assembly 200 by a clamping apparatus.

In several embodiments, interfaces can have fewer than, or more than twelve connection points and/or polygon sides.

In many embodiments, interfaces can be sized and configured to direct each of one or more attached implements to an appropriate location relative to a point of interest (e.g., the intended weld pool location, the intended additive deposit location, and/or another point of interest). The appropriate position and orientation for each type of component can be different.

Interfaces, in accordance with many embodiments of the invention can be used to mount one or more different types of additive manufacturing nozzle assemblies (e.g., WAAM plasma nozzles, WAAM dual plasma nozzles as described in U.S. Provisional Patent Application No. 63/482,763, filed Feb. 1, 2023, which is incorporated by this reference). In several embodiments, additive manufacturing nozzle assemblies can be mounted to interfaces using one or more connection points. Suitable fasteners for the connection points include quarter-turn fasteners. Advantageously, in at least one embodiment, the nozzle assemblies can be mounted with the same connection points using the same fasteners used to mount sensors and/or actuators. An additive manufacturing nozzle assembly can be mounted to an interface with 1, 2, 3, or another number of connection points in accordance with embodiments of the invention.

3-D printing of metallic structures typically involves using an energy source to create a weld pool, and feeding a metal wire (feed material) into the weld pool by way of a printing head or printing head nozzle. Energy is used to create the weld pool. Some systems use electricity and others use lasers for the energy. Electric systems typically pass an electric current through the feed wire into the weld pool. The printing head, and subsequently the weld pool can be moved. As the printing head and the welding pool moves, the trailing edge of the pool cools and solidifies. Through this process of gradually moving the printing head along a path can lead to a fully printed part.

The process by which material is deposited can be controlled by the use of shielding gas around the feeding material. The shielding gas can help to make a better weld pool for an overall better part. The shielding gas can protect the weld pool from corrosive gases and moisture.

In various embodiments, an additional arc (e.g., an ionizing arc capable of generating plasma) can be introduced between the electrode (e.g., an electrode different from the feed wire, a tungsten electrode) and another surface (e.g., a nozzle during plasma ignition, and/or a workpiece post-ignition). The additional arc can generate an assisting plasma. The assisting plasma generated by the additional arc can be directed to the workpiece. A WAAM nozzle capable of implementing the assisting plasma and a primary arc (issuing from a primary feed wire) can be referred to as a dual plasma nozzle.

In accordance with embodiments of the invention, the assisting plasma can be located between the feed wire and the shielding gas. The assisting plasma can issue from an assisting plasma channel. Assisting plasma channels can have circular exits that are concentric with feed wires. The feed wire can be concentric with an exit of a shielding gas. The inside of the assisting plasma channel be formed of two electrically isolated surfaces. An electrode side of the channel can be electrically connected with an electrode. An outer body side of the channel can opposite the electrode side. The outer body side can have an insulating coating on a first portion of the channel located distal relative to the electrode. The outer body side can have an uninsulated second portion of the channel located proximal relative to the electrode.

In some embodiments, the torch is clamped using components machined from a material, Garolite (G10-FR4), and/or other fiberglass-epoxy laminate, other composite material, and/or some combination thereof. In accordance with several embodiments of the invention, the surface clamping the torch is electrically insulated. Electrical insulation from the torch can be advantageous to avoid damage to sensors. In several embodiments, a clamping apparatus can be similar to a V-block jig for ease of machining. In certain embodiments, a clamp can be a rounded clamp matching a torch diameter.

In several embodiments, two riser plates can be spaced apart by a minimum amount to allow a torch to extend between the two riser plates.

The torch can be clamped, in accordance with embodiment of the invention, by the modular interface at a height that corresponds to a sensor attachment height, or can be offset from this height. In several embodiments, the torch can be clamped as close to the torch endpoint as possible without interfering with a torch nozzle.

While specific processes and/or systems for modular interfaces are described above, any of a variety of processes and/or systems can be utilized for modular interfaces as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to modular interfaces, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

### Cold-Wire Actuator

In some embodiments, an applicator actuator is fixedly mounted to a modular interface. In several embodiments, applicator actuators can provide one or more degrees of freedom for moving an attached additive manufacturing applicator. In accordance with various embodiments of the invention, the applicator actuator can control where a cold wire is fed into a weld pool. This can enable hotter welding, quick manipulation of the cold wire during an additive manufacturing process, and/or adjustable weld contact areas. In some embodiments, the applicator actuator can be used to shape a weld pool, and a feed rate of material for deposition. Various embodiments include the ability to move an additive manufacturing applicator to enable adding material to the outside of a wall, the inside, or in the middle.

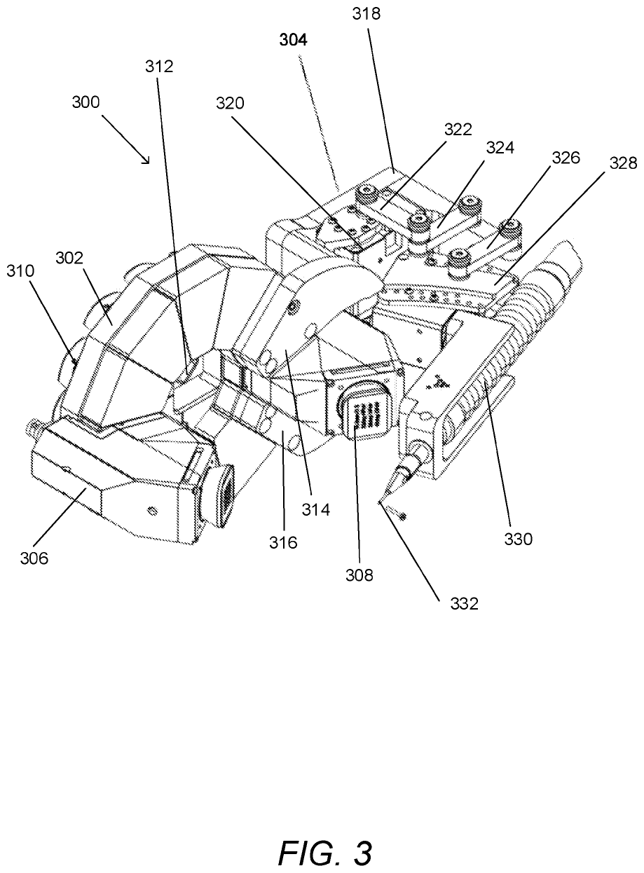

In several embodiments, an end-effector assembly mounted to a robotic actuator can include a modular interface with a mounted applicator actuator. The applicator actuator can be configured to actuate an additive manufacturing applicator in one or more degrees of freedom. An example modular interface with a mounted applicator actuator is conceptually illustrated in FIG. 3. An assembly 300 can include a modular interface 302. A tool actuator 304 can be fixedly mounted to the modular interface 302. A first sensor 306 and a second sensor 308 can be mounted to the modular interface 302.

The modular interface 302 can include a set of connection points 310 (e.g., a set of twelve connection points). In certain embodiments, the set of connection points can enable connection between a front side of a modular interface and a top side of an attachment. The modular interface 302 can include a central aperture 312. In some embodiments the central aperture can be configured to fixedly mount an additive manufacturing applicator (e.g., a hot-wire torch). The first sensor 306 and the second sensor 308 can be mounted to a front side of the modular interface 302. In certain embodiments, the first sensor can be a laser sensor, welding camera, infrared camera, and/or visible light camera. In numerous embodiments, the second sensor can be a laser sensor, welding camera, infrared camera, and/or visible light camera.

The tool actuator 304 can be mounted to a front side of the modular interface 302. The tool actuator 304 can have a first mounting arm 314, and a second mounting arm 316. A first mounting arm (e.g., first mounting arm 314) and second mounting arm (e.g., second mounting arm 316) can be a single component in accordance with embodiments of the invention. The first mounting arm 314 and the second mounting arm 316 can be spaced apart. The spacing can be sufficient to allow the second sensor 308 to be mounted to the modular interface 302 at a connection point located between the first mounting arm 314 and the second mounting arm 316. The first mounting arm 314 and second mounting arm 316 are rigidly connected to a frame 318. The frame 318 can fixedly mount an actuating component 320. In several embodiments, the actuating component is an electric motor. The actuating component 320 is drivingly coupled to a movable link 322. The movable link 322 can form a part of a closed chain movable linkage (e.g., a 4-bar linkage). The closed chain movable linkage can include the movable link 322, a second movable link 324, a third movable link 326, and a fourth movable link in the form of a tool holder assembly 328. The closed chain movable linkage allows controlling the position of the tool holder assembly 328. The tool holder assembly 328 can hold, support and/or position a tool 330. In some embodiments, the tool can be an additive manufacturing applicator. In several embodiments, the tool can be a cold-wire applicator. In accordance with embodiments of the invention, the cold-wire applicator can be capable of advancing a cold-wire. Advancing a cold-wire, can, in several embodiments, correspond to advancing a cold-wire into a weld pool. In many embodiments, a second actuating component can be mounted to the frame for driving one or more movable links. In accordance with several embodiments of the invention, a tool mounted to a tool holder assembly can include an actuator capable of advancing a wire. As used herein, a “cold” wire refers to a feed wire that does not carry electrical energy into the weld pool or carries less electrical energy than the “hot” wire, which is the electrode wire or feed wire carrying electrical energy into the weld pool. A cold wire can be pre-heated before it is deposited. Use of a cold wire in conjunction with a hot wire increases the mass of metal deposited into the weld pool. Cold wires are described in U.S. patent application Ser. No. 17/544,408, filed on Dec. 7, 2021 (published as U.S. Patent Application Publication No. 2023/0173601) and U.S. patent application Ser. No. 18/451,688, filed on Aug. 17, 2023, the entire contents of both of which are incorporated by reference in this disclosure.

The tool 330 can have an endpoint 332. The endpoint 332 can be adjacent to an additive manufacturing deposition site. The first sensor 306 and the second sensor 308 are fixedly positioned relative to the first mounting arm 314 and the second mounting arm 316. In the configuration depicted in FIG. 3, the second sensor 308 can be mounted at 12 o'clock, the first mounting arm 314 and the second mounting arm 316 respectively can be mounted at the 11 o'clock and 1 o'clock positions, and/or the first sensor can be mounted at the 6 o'clock.

In several embodiments, a sensor can be mounted between the mounting arms of a tool actuator. In some embodiments, when a sensor is mounted relative to a tool actuator it can be configured such that a tool mounted to the tool actuator and the sensor are aligned with each other (e.g., share a plane of reflection, share a plane of symmetry, are aligned with each other along a plane).

In various embodiments, the tool actuator is configured to change an angle of inclination between a datum plane and a longitudinal axis the runs along the length a tool mounted to the tool actuator. In various embodiments, a datum plane can be plane parallel to an front side of a modular interface and interesting an endpoint of a tool. In several embodiments, the tool actuator is configured to translate the endpoint of a mounted tool along a longitudinal axis that runs along the length of the mounted tool.

In accordance with some embodiments of the invention, one or more (e.g., 1, 2, 3 or another number) of tool actuators can be mounted to a modular interface. Each of the tool actuators can be connected to an additive manufacturing applicator (e.g., a cold wire for a WAAM system). The additive manufacturing applicator can include an adjustable stick-out distance of a cold-wire. The tool actuator, in some embodiments, has a range of motion (e.g., of around 3 degrees) with respect to the endpoint of a hot wire torch. The range of motion can be motion to either side of a pre-selected angle in accordance with embodiments of the invention. The pre-selected angle can be pre-selected using the holes disposed on a surface of a tool actuator. In many embodiments, a pre-selected angle can be selected according to the type of material being applied.

While specific processes and/or systems for modular interfaces with mounted applicator actuators are described above, any of a variety of processes and/or systems can be utilized for modular interfaces with mounted applicator actuators as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to modular interfaces with mounted applicator actuators, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

### Torch Configurations

In some embodiments, an additive manufacturing applicator is fixedly and centrally mounted to a modular interface. In accordance with several embodiments of the invention, the various sensors and/or other tools (e.g., cold-wire actuator) are annularly arranged around a centrally mounted additive manufacturing applicator. In some embodiments, the mounted equipment is rigidly attached to the modular interface to minimize relative unintended relative motion between the various components (e.g., sensor, additive manufacturing applicators). Minimizing the unintended relative motion between component can improve manufacturing accuracy because systematic random measurement error on data received from the sensors is reduced.

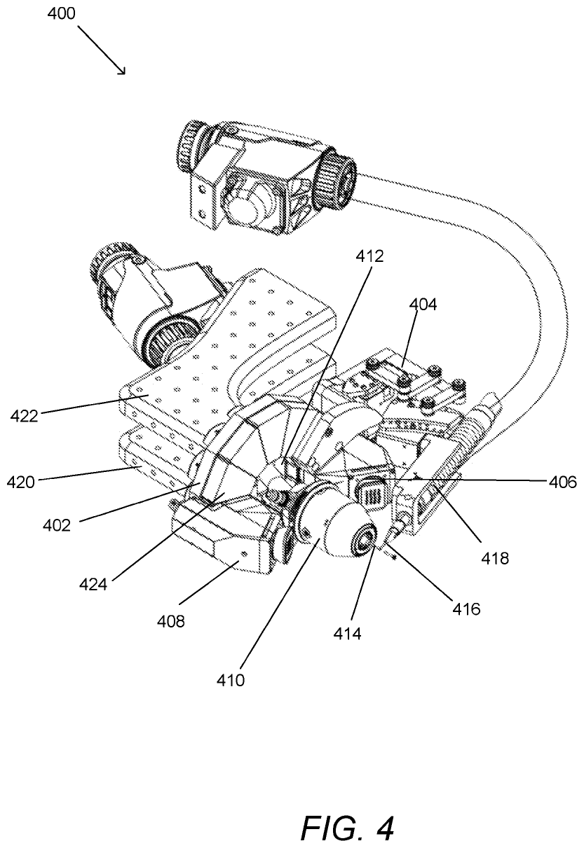

In several embodiments, an end-effector assembly mounted to a robotic actuator can include an additive manufacturing applicator that is fixedly and centrally mounted to a modular interface. An example end-effector including an additive manufacturing applicator that is fixedly and centrally mounted to a modular interface is conceptually illustrated in FIG. 4. An assembly 400 can include a modular interface 402. A tool actuator 404 can be fixedly mounted to the modular interface 402. A first sensor 406 and a second sensor 408 can be mounted to the modular interface 402. An additive manufacturing applicator 410 can be centrally located and protrude through the central aperture 412. The additive manufacturing applicator 410 can include an endpoint 414. The endpoint 414 can be proximate to an endpoint 416 associated with a tool 418 that is mounted in the tool actuator 404. The first sensor 406 can be oriented to obtain sensory data based on observing a position proximate to the endpoint 416. The second sensor 408 can be oriented to obtain sensory data based on observing a position proximate to the endpoint 414. The endpoint 414 and the endpoint 416 can be approximately coincident. An angle between a longitudinal axis of the additive manufacturing applicator 410 and the longitudinal axis of the tool 418 can be adjusted using the tool actuator 404. The modular interface 402 can be fixedly mounted to a first riser plate 420 and a second riser plate 422. The first riser plate 420 and the second riser plate 422 can be parallel and spaced from each other. The additive manufacturing applicator can extend through the space between the first riser plate 420 and the second riser plate 422. Covers 424 can be mounted to the modular interface 402. Covers, in accordance with embodiments of the invention, can protect portions of modular interfaces not coupled to other components.

In various embodiments, one or more sensors and/or a tool actuator can be circumferentially disposed around a central aperture of a modular interface. The central aperture can include clamping means configured for fixing a position of an additive manufacturing applicator relative to a modular interface. In several embodiments, the sensors are configured to obtain readings based on observing a location determined relative to an endpoint of an additive manufacturing applicator. In numerous embodiments, the location determined relative to the endpoint of an additive manufacturing applicator can be a location coincident with the endpoint of an additive manufacturing applicator. In several embodiments, the additive manufacturing applicator is a hot-wire torch. In various embodiments, the mounted tool can be a cold-wire and/or a hot-wire torch.

While specific processes and/or systems for end-effectors including additive manufacturing applicators that are fixedly and centrally mounted to modular interfaces are described above, any of a variety of processes and/or systems can be utilized for end-effectors including additive manufacturing applicators that are fixedly and centrally mounted to modular interfaces as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to end-effectors including additive manufacturing applicators that are fixedly and centrally mounted to modular interfaces, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

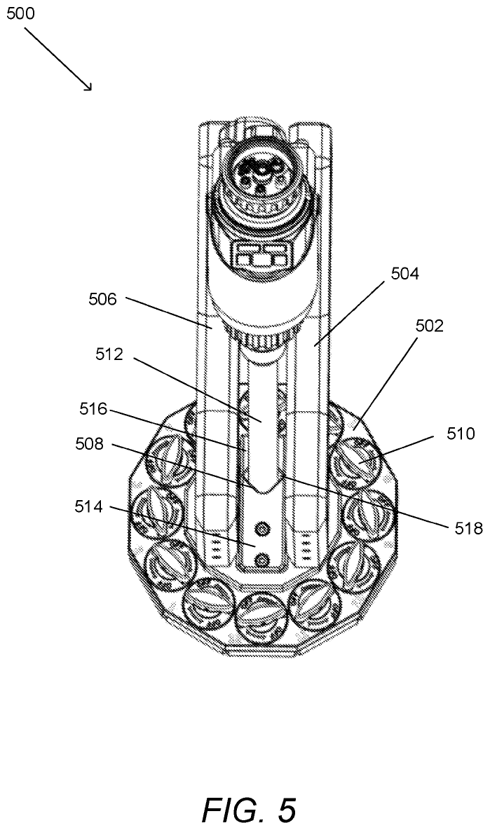

An example modular interface with a centrally mounted additive manufacturing applicator is conceptually illustrated in FIG. 5. An assembly 500 can include a modular interface 502. The modular interface 502 can be mounted to a first riser plate 504, and a second riser plate 506. The first riser plate 504 can be parallel to the second riser plate 506. The first riser plate 504 can be spaced apart from the second riser plate 506. The modular interface 502 can include a clamping point 508. The clamping point 508 can be centrally located as compared to a set of circumferential connection points 510. The clamping point 508 can fixedly couple the modular interface 502 to the additive manufacturing applicator 512. The clamping point can include a first portion 514 and a second portion 516. The additive manufacturing applicator 512 can extend between the first riser plate 504 and the second riser plate 506. The additive manufacturing applicator 512 can extend through an aperture 518 of the modular interface. In several embodiments, an endpoint of the additive manufacturing applicator can be past the front side of the modular interface 502. In some embodiments, a modular interface can be attached to a robot via one or more riser plates.

While specific processes and/or systems for modular interfaces with centrally mounted additive manufacturing applicators are described above, any of a variety of processes and/or systems can be utilized for modular interfaces with centrally mounted additive manufacturing applicators as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to modular interfaces with centrally mounted additive manufacturing applicators, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or restart automation systems as described herein.

### End-Effector Configurations

In various embodiments, a modular interface can have a selected configuration for enabling improved additive manufacturing accuracy. The position of the sensors relative to a site of interest (e.g., an additive manufacturing deposition site and/or a weld poll) can affect the accuracy of measurements from sensors.

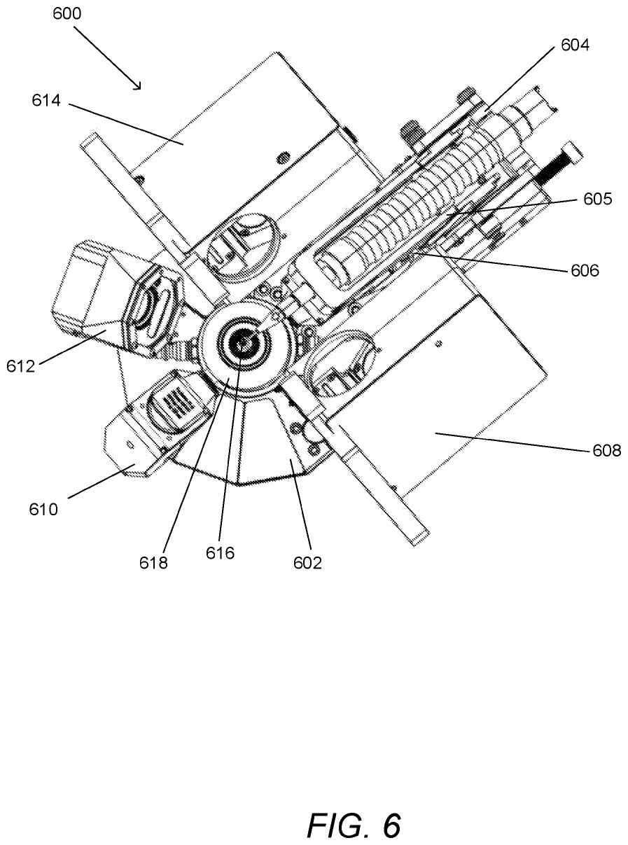

In several embodiments, sensors can be circumferentially arranged around a central point. The central point can correspond to the location of an additive manufacturing applicator endpoint. An example configuration for a modular interface is conceptually illustrated in FIG. 6. The assembly 600 includes a modular interface 602, a tool actuator 604, a first sensor 606, a second sensor 608, a third sensor 610, a fourth sensor 612 and a fifth sensor 614. The first sensor 606 can be located between a front side of the modular interface 602 and an actuated tool holding portion 605 of the tool actuator 604. In various embodiments, each of the sensors can have a type selected from the list of a laser sensor, welding camera, infrared camera, and/or visible light camera. In some embodiments, the first sensor 606 is a welding camera. The first sensor 606 can be configured to be directed at an endpoint 616. The endpoint 616 can be a hot-wire torch. In various embodiments, the second sensor 608 can be a laser sensor. The second sensor 608 can be configured to be directed at a location offset (e.g., by about 2 inches, by about 2.1 inches) from the endpoint 616. In various embodiments, the third sensor 610 can be a welding camera. The third sensor 610 can be configured to be directed at an endpoint 616. In various embodiments, the fourth sensor 612 can be a visible light camera. The fourth sensor 612 can be configured to be directed at the endpoint 616. In various embodiments, the fifth sensor 614 can be a laser sensor. The fifth sensor 614 can be configured to be directed at a location offset (e.g., by about 2 inches, by about 2.1 inches. The sensors can be circumferentially arranged around a central point that corresponds to an endpoint 616 of an additive manufacturing applicator 618.

In the illustrated configuration the tool actuator 604 is attached to the modular interface at the 11 o'clock and 1 o'clock positions; the first sensor 606 is attached to the modular interface at the 12 o'clock position; the second sensor 608 is attached to the modular interface at the 2 o'clock position; the third sensor 610 is attached to the modular interface at the 6 o'clock position; the fourth sensor 612 is attached to the modular interface at the 8 o'clock position; and the fifth sensor 614 is attached to the modular interface at the 10 o'clock position; and the endpoint 616 is centrally located with respect to the circumferential o'clock positions. In several embodiments, the position of the various components can be changed. The modular interface can support various configurations via circumferential connecting points, and a central clamping point. Various configurations can be useful to support additive manufacturing of a widened range of products.

While specific processes and/or systems for configurations for modular interfaces are described above, any of a variety of processes and/or systems can be utilized to configurations for modular interfaces as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to configurations for modular interfaces, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

### Localized Fume Extraction and Arc Protection

In various embodiments, additive manufacturing applicators can require fume extraction for proper use. In several embodiments fume extraction is provided locally. Localized fume extraction can advantageously reduce capital investment and save energy as compared with whole space fume extraction. In various embodiments, localized fume extraction systems can include positionable arms. Using positionable arms can advantageously increase the variety of geometries for which a robot mounted additive manufacturing applicator can be used for. In various embodiments, localized fume extraction can be important in applications where printing is conducted horizontally. Without localized fume extraction horizontal printing can result in fumes being trapped inside spaces (e.g., inside tubes and/or barrels) of a part being manufactured.

In numerous embodiments, an arc protection assembly can protect people in the vicinity of an additive manufacturing robotic system from viewing a deposition site. In certain embodiments, the arc protection assembly shields viewers from a welding arc used during an additive manufacturing process.

In several embodiments, local fume hoods can be positioned using positioning arms to a customizable position relative to a modular interface, this is advantageous to make the additive manufacturing end effector customizable and thereby adaptable to a greater range of product geometries.

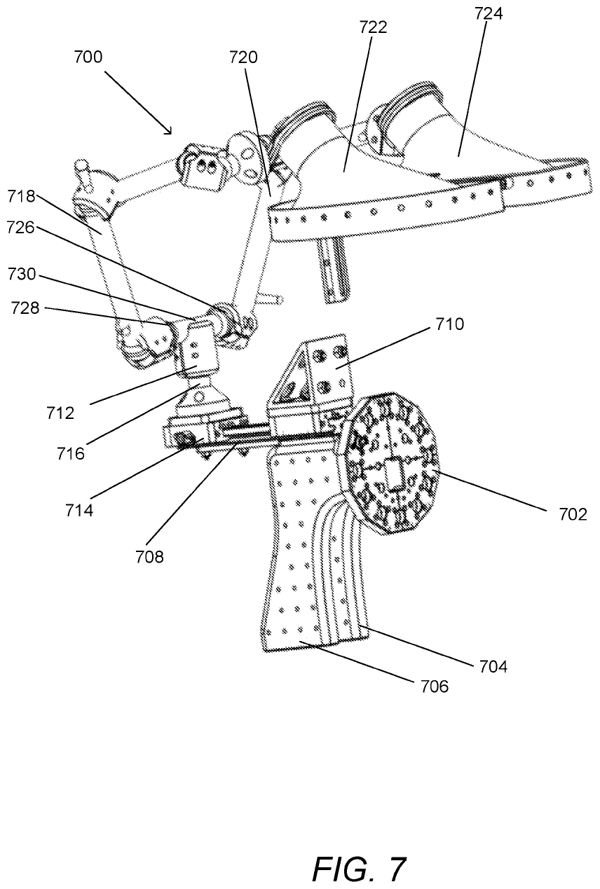

In numerous embodiments, a localized fume extractor can extract fumes during an additive manufacturing process. The localized fume extractor can have a fixed relative position to an additive manufacturing applicator. An example of a localized fume extractor is conceptually illustrated in FIG. 7. An end effector assembly 700 can include a modular interface 702, a first riser plate 704, a second riser plate 706, a positioning rail 708, an arc protection bracket 710, and a localized fume extraction assembly 712. The riser plates 704, 706 can be fixedly coupled to the modular interface 702. The positioning rail 708 can be fixedly coupled to the riser plates 704, 706. In certain embodiments, a modular interface has a fixed relative position with respect to a positioning rail. The arc protection bracket 710 can be slidably mounted to the positioning rail 708. The fume extraction assembly 712 can be mounted to the positioning rail 708. In various embodiments, a positioning rail allows translational movement of a fume extraction assembly and/or an arc protection bracket. In accordance with several embodiments of the invention, the translational movement is along a longitudinal axis of the rail. In some embodiments, the longitudinal axis of the rail is perpendicular to a plane defined by the front side of a modular interface (e.g., of a modular interface that is fixedly coupled to the rail. In some embodiments, an arc protection bracket is mounted closer to the modular interface that the fume extraction assembly.

The fume extraction assembly 712 can include a rail bracket 714, a positioning arm center mount 716, a first positioning arm 718, a second positioning arm 720, a first fume hood 722, and a second fume hood 724.

The rail bracket 714 can be slidably mounted to the positioning rail 708. The positioning arm center mount 716 can be rotationally attached to the rail bracket 714. In certain embodiments, a longitudinal axis of the positioning arm center mount can be perpendicular to and/or intersecting with a longitudinal axis of a positioning rail. The center mount 716 can include a first joint 726, and a second joint 728. In various embodiments, the first joint and the second joint can be ball and socket joints. The first joint 726 can movable connect the first position arm 718 to the center mount 716 on a first side. The second joint 728 can movable connect the second position arm 720 to the center mount 716 on a second side. The first and second side can be spaced apart by a bar 730, the bar 730 can have a longitudinal axis. The bar 730 longitudinal axis can be perpendicular to the longitudinal axis of the center mount 716. The first and second positioning arms 718 and 720 can be connected to the first and second fumes hoods 722, and 724.

In certain embodiments, each positioning arm connects, at a terminal end, to a fume hood. In many embodiments, the fume hood, one positioned is fixed relative to the modular interface during at least a portion of a manufacturing process. In accordance with certain embodiments of the invention, the fume hoods are configured to connect with a vacuum for fume removal. In certain embodiments, the fume extraction assembly is configured to allow the positioning of fume hoods relative to a modular interface. In several embodiments, local fume hoods can be positioned using positioning arms to a customizable position relative to a modular interface, this is advantageous to make the additive manufacturing end effector customizable and thereby adaptable to a greater range of product geometries. In various embodiments the positioning arms can have 1, 2, 3, 4, 5, 6, or another number of links, joints and/or degrees of freedom. In many embodiments, arc protection brackets can be configured to fixedly mount an arc protection assembly. In various embodiments the fume hoods can have flattened leading edges, this can be advantageous for advancing the fume hoods closer to a part for better fume extraction. One or more positioning arms and associated fume hoods can be included in a local fume extraction assembly. In several embodiments, a local fume extraction assembly can include 1, 2, 3, 4, or another number of positioning arm and fume hood combinations. The fume hoods, in accordance with various embodiments of the invention can have a fixed relative position as compared to a modular interface for the duration of an additive manufacturing process. In numerous embodiments, a removable weld curtain can be attached to a fume hood. In several embodiments, the weld curtain can be attached to a snubbed leading edge of a fume hood.

While specific processes and/or systems for localized fume extractors are described above, any of a variety of processes and/or systems can be utilized for localized fume extractors as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to localized fume extractors, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

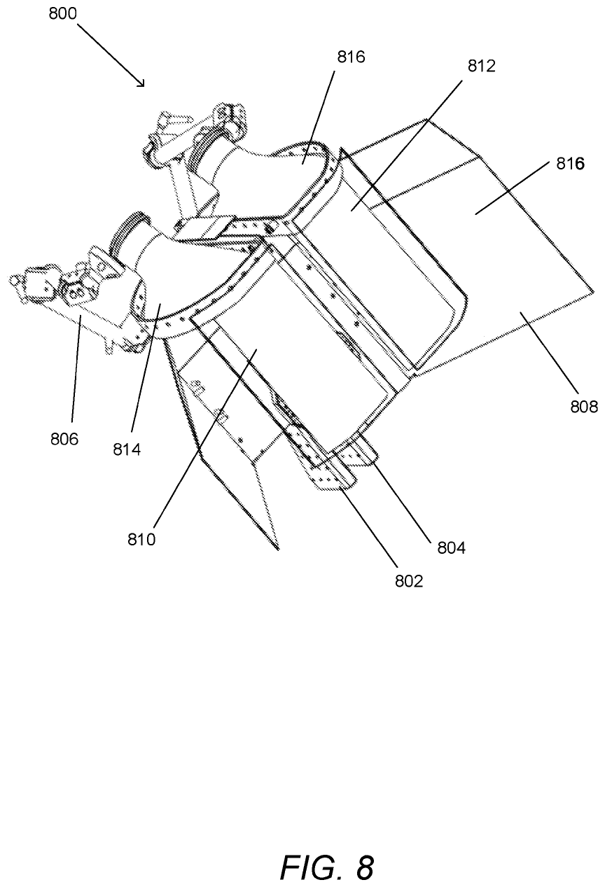

An arc protection assembly can protect people in the vicinity of an additive manufacturing robotic system from viewing a deposition site in numerous embodiments. In certain embodiments, the arc protection assembly shields viewers from a welding arc used during an additive manufacturing process. An example of an arc protection assembly is conceptually illustrated in FIG. 8. An arc protection and fume extraction assembly 800 can include a first riser plate 802, a second riser plate 804, a fume extraction assembly 806 and an arc protection assembly 808. The fume extraction assembly 806 and the arc protection assembly 808 can translate relative to the first and second riser plates 802 and 804. The fume extraction assembly 806 can include a first curtain 810 and a second curtain 812, The first and second curtains 810 and 812 can be attached to a front side of a first and second fume hood 814 and 816. In various embodiments, curtains can be made of rigid, transparent, opaque, and/or non-rigid materials.

The arc protection assembly can include a shield 816 and an arc protection bracket (e.g., arc protection brackets 710). The shield 816 can be mounted on the arc protection bracket. Adjusting the position of the arc protection bracket can adjust the position of the shield 816. In some embodiments, shields can be made of opaque materials.

While specific processes and/or systems for arc protection assemblies are described above, any of a variety of processes and/or systems can be utilized for arc protection assemblies as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to arc protection assemblies, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

### Automation of Restarts

A restart can be an alignment of a robot along an axis, such as an x-restart in the x-axis (e.g., radial axis), after a stop and/or during an additive manufacturing process. A restart can be an x-restart, and/or a robot can be aligned to an x-axis (e.g., a radial axis) during a rest. For clarity and ease of describing embodiments, the description provided herein describes an automated restart process as applied to an x-restart, although the process, methods, apparatuses, and systems described herein may be applied to automated restarts in any axis needed or desired during a print. For example, a coordinate transformation can be formed in conjunction with the process below to automate a restart in any axis.

An x-restart robot command can be generated based on a x-offset value. Alignment of the robot in the x-axis is beneficial before and during starting a print to improve print quality, reduce work stoppages, and broaden the range of parts that can be printed by an additive manufacturing system (e.g., WAAM system).

In WAAM processes, after stopping a print, the part being manufactured can cool down and shrink. The part can radially become smaller than nominal.

In several embodiments, to improve print quality, the additive manufacturing applicator can be aligned to the part before starting printing and/or continuously during printing. X-restarts can be performed to align an applicator to a part before a print is started (e.g., a static x-restart). In several embodiments, once printing starts, the part expands because of the heat input. X-restarts can be used to continually keep up with part expansion (e.g., dynamic x-restarts).

Without automated x-restarts, manual restarts can be required. Automated x-restarts can have improved accuracy as compared to manual x-restarts, and automated x-restarts can be performed dynamically. Manual x-restarts can be inaccurate and cause the requirement of additional unexpected operations (e.g., machining). In certain embodiments, X-restarts can eliminate recovery periods from mistakes associated with manual x-restarts. In a number of embodiments, X-restarts can allow additive manufacturing processes to restart on a click of a button. X-restarts can, in some embodiments be dynamic to improve print accuracy throughout the print.

In certain embodiments, X-restarts allows automatic alignment of a part to a torch while the arc is off and/or keep up with part expansion once arc is on.

In accordance with some embodiments of the invention, x-offset calculations can assume a circular cross-section of a part being printed. In several embodiments the cross section of a part can be perfectly circular when the arc is off.

In certain embodiments, when the arc is on, there is a radial offset locally, right under the torch because of thermal expansion. In various embodiments, the thermal expansion offset changes depending how far we are from a rib (or other stiffened sections). Thermal expansion offsets can be generated from simulations.

In some embodiments, best curve fits based on data from thermal expansion simulations can be used with x-restart processes.

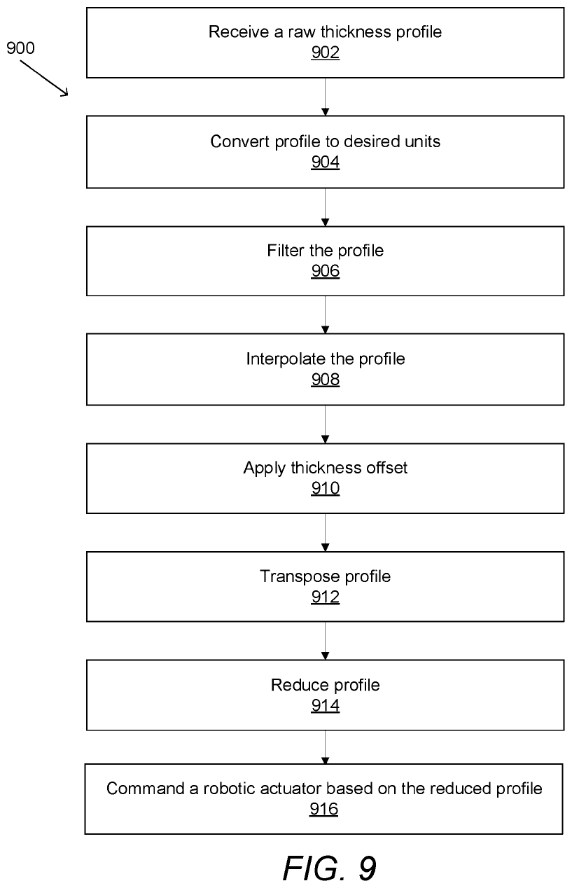

In several embodiments, a processor can receive data from a sensor, and based on that data can generate a spatial profile (also referred to herein as “profile”), such as a point cloud for a point of interest on a part during an additive manufacturing process (e.g., a welding based additive manufacturing (WAM) process, a wire arc additive manufacturing (WAAM) process). In another embodiment, the spatial profile may comprise a thickness profile. An example process for generated a profile for a part during a WAM process is conceptually illustrated in FIG. 9. The process 900 can receive (902) a raw profile. In some embodiments, the profile can be received from a sensor (e.g., a laser sensor). The process 900 can convert (904) the profile to a desired set of units. The process 900 can filter (906) the profile. In certain embodiments, the profile can be filtered to eliminate outliers. The process 900 can interpolate (908) to profile to obtain a profile estimate. The process 900 can apply (910) a thickness offset. The thickness offset can be based on a simulation. The thickness offset and related simulations are further described elsewhere herein. The process 900 can transpose (912) the profile. The process 900 can reduce (914) the profile. The process 900 can command (916) a robotic actuator to position an end effector based on the reduced profile.

While specific processes and/or systems for generating a profile for a part during a WAAM process are described above, any of a variety of processes and/or systems can be utilized to generate a profile for a part during a WAAM process as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to generating a profile for a part during a WAAM process, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or X-restart automation systems as described herein.

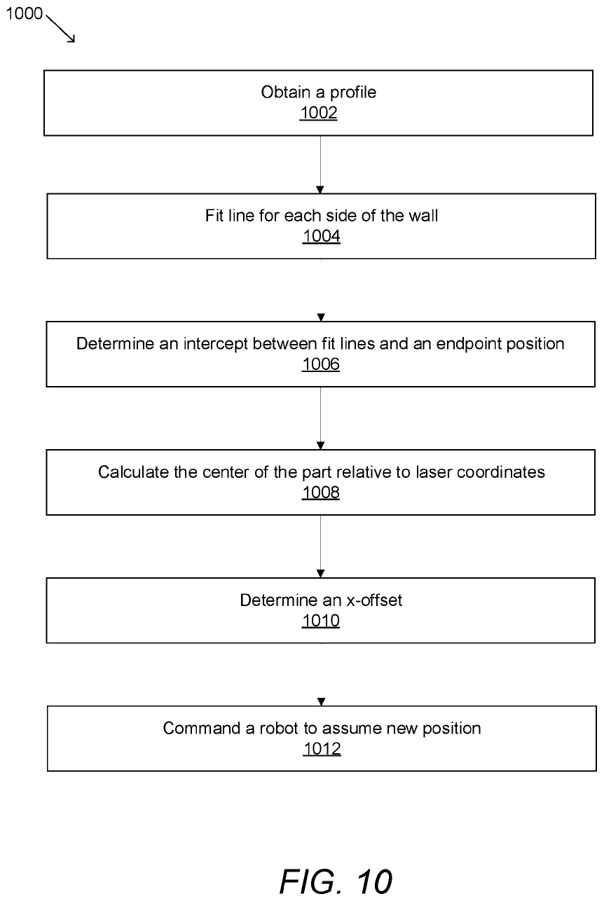

In several embodiments, a processor can command a robot to assume a new position based on a determined x-offset. An example process for commanding a robot to assume a new position based on a determined x-offset is conceptually illustrated in FIG. 10. A process 1000 can obtain (1002) a profile. The profile can be a reduced profile. The profile, in some embodiments, can be obtained as described in relation to FIG. 9. The process 1000 can fit (1004) a line for each side of the wall of a printed component. In certain embodiments, the fitted line is generated based on the profile and/or based on a simulation of a weld pool profile. The process 1000 can determine (1006) an intercept between the fit lines and an endpoint position. The endpoint can be the endpoint of an additive manufacturing applicator (e.g., a hot-wire torch). The endpoint location can correspond to a weld pool location. The process 1000 can calculate (1008) the center of the part relative to laser coordinates based on the determined intercept. Based on the center of the part, the process 1000 can determine (1010) a x-offset. In various embodiments, the x-offset is measured in a radial direction. Based on the determined x-offset the process 1000 can command a robot to assume a new position. In several embodiments the robot is fixedly attached to an additive manufacturing end effector assembly as is described herein.

In some embodiments, filtering a profile can include filtering any values that are outside of a laser sensor (e.g., model LJ V7080) accuracy bounds. Profile filtering can remove outliers by comparing a delta around each point. When the delta exceeds threshold, then it is considered an outlier and can be removed by filtering.

Reducing the profile, in some embodiments, can include computing derivatives of laser sensor profiles. Based on the derivative, processes can determine if the derivative passes one or more threshold values. In several embodiments, threshold values can be determined based on the geometry of a part being manufactured. In accordance with numerous embodiments of the invention, data can be reduced by using a length (e.g., around 10 millimeters) worth of data (e.g., measured from a datum on the most recently printed surface).

In several embodiments, processes can generate a fit line for each side of the wall of a part. The fitted line can be in standard form (Ax+By+C=0), or in another form. An intersection can be determined between fitted lines and a determined contact tip position. A contact tip position can refer to an endpoint of an additive manufacturing applicator.

In certain embodiments, the contact tip position (determined based on a calibration), can be used to generate a horizontal line. Based on the horizontal line and the fitted lines, and using Cramer's Rule from these intersections, a midpoint x (e.g., a center of a part being manufactured) can be determined.

A distance from a laser to a contact tip can, in various embodiments, be obtained through calibration. Contact tip positions can be determined by calibration. In certain embodiments, processes can be configured to receive geometric and other information about a part. In certain embodiments, a radius of a part (and/or other geometric descriptions of a part) can be received by a process. The information can be received from a user (e.g., input by a user), or can be received in any other way (e.g., via a network interface).

In some embodiments, the center of the part relative to the robot coordinates can be determined by calculating:

Robot_x=contact_tip_x_position−radius; and

Robot_y=laser_to_contact_tip_distance

x-offset can be determined. In several embodiments, the x_offset can be calculated as

x_offset=(((midpoint_x−Robot_x)²+(0.0−Robot_y)²)^{1/2}−radius).

Various sensors can be used to gather data for calculating an x-offset. In some embodiments, cameras can be used to detect the part.

In accordance with several embodiments of the invention, lasers can be used to detect the part. In several embodiments, lasers can provide more accurate x-offset calculations than cameras. The placement of the laser is important to get high quality data. When the laser sensor observes an area too close to the arc, then the generated data is noisy. When the laser sensor observes an area too far away from the part, a thermal expansion of the part can add to uncertainty. In certain embodiments, the laser scanner is placed about 2 inches, about 2.1 inches, or another distance from the center of the arc. In accordance with embodiments of the invention, an optimum distance can vary depending on the properties of an additive manufacturing process (e.g., WAAM system used, power level used, cold wire, etc).

In several embodiments, x-offsets can be determined based on thermal expansion simulations. The simulations can be pre-calculated to allow performance of x-restarts without delays due to waiting for simulations to be completed. In several embodiments, simulations can require, as input for their generation, sensor positioning, laser sensor positioning, part geometry, cold wire inclusion, materials used, thermal effects from other sources (e.g., thermal effects from simultaneous print by multiple robots on single part) and/or power levels for arc. Determined x-restart values can be based on sensor positioning, laser sensor positioning, part geometry, cold wire inclusion, materials used and/or power levels for arc.

Two laser sensors (e.g., Keyence) can be used, in several embodiments, to generate data for determining an x-offset. For example, the laser sensors may comprise a Keyence LJ-V7080 sensor, other LJ-V7000 series sensor, other laser profiling sensor or line laser, or some combination thereof.

While specific processes and/or systems for commanding a robot to assume a new position based on a determined x-offset are described above, any of a variety of processes and/or systems can be utilized to command a robot to assume a new position based on a determined x-offset as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to commanding a robot to assume a new position based on a determined x-offset, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

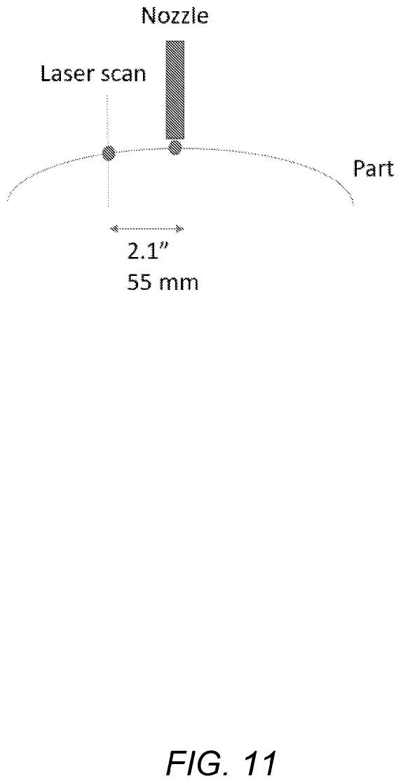

In several embodiments, sensors can be positioned such that they target an observation point positioned relative to a point of interest. A location of a laser scan relative to an additive manufacturing nozzle (e.g., endpoint) is conceptually illustrated in FIG. 11. The nozzle 1100 is centrally located with respect to a weld pool 1102. A sensor can be arranged such that it observes a laser scan location 1104. The laser scan 1104 location can be 2.1 inches, or 55 millimeters from the central axis of the nozzle 1100. In several embodiments, a point of interest can correspond to an expected weld pool location. The weld pool can be concentric with the endpoint of an additive manufacturing applicator. In certain embodiments, the additive manufacturing applicator is a WAAM. When the manufacturing is in process the arc can disrupt sensor accuracy. In some embodiments, sensors are positioned to take observations at location spaced apart from the endpoint of the additive manufacturing applicator (e.g., the source of the arc). In several embodiments, sensors can be configured to take laser scans at an offset distance (e.g., of about 2.1 inches or 55 millimeters) from a nozzle. In various embodiments, a desired offset distance can be determined based on materials being used, power levels being used, temperature, and other factors. In several embodiments, optimal offsets can be determined based on simulation results. In various embodiments, simulations can be used to generate profiles of geometries under various WAAM conditions. In accordance with several embodiments of the invention, simulations can be calculated on the fly or can be calculated in advance.

While specific processes and/or systems for a location of a laser scan relative to an additive manufacturing nozzle are described above, any of a variety of processes and/or systems can be utilized for a location of a laser scan relative to an additive manufacturing nozzle as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to the location of a laser scan relative to an additive manufacturing nozzle, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or restart automation systems as described herein.

### Additive Manufacturing Robotic System

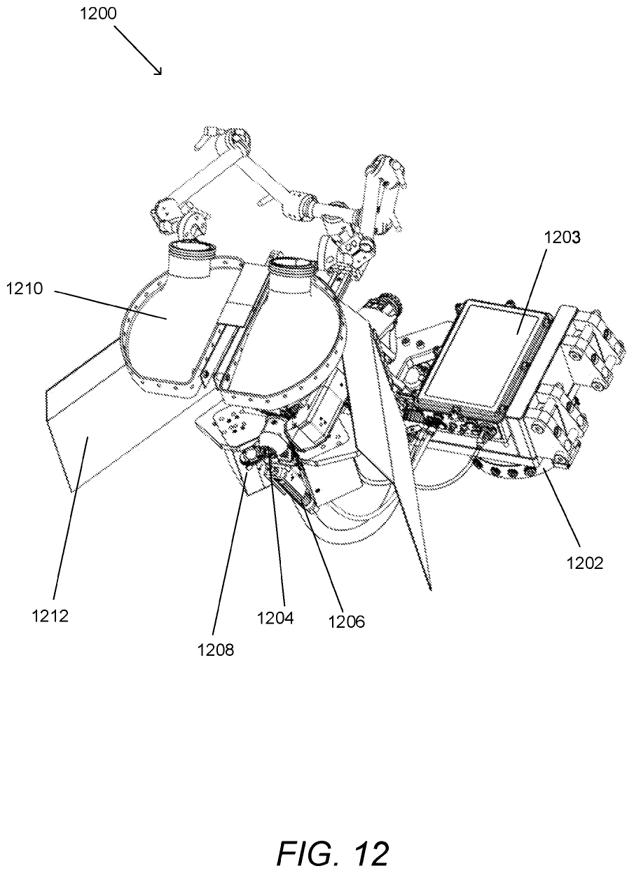

Additive manufacturing devices can utilize an end-effector assembly mounted to a robotic actuator. An additive manufacturing end-effector assembly configured to mount to a robotic actuator is conceptually illustrated in FIG. 12. The assembly 1200 can include a robot attachment bracket 1202, a controls module 1203, a first additive manufacturing applicator 1204, a second additive manufacturing applicator 1206, sensors 1208, fume extraction assembly 1210, and an arc protection assembly 1212. In several embodiments, an attachment bracket can be configured to attach to a robotic actuator (e.g. a robotic arm, a robotic cart). In some embodiments, the controls module can include a computer system. In accordance with various embodiments of the invention, the controls module can be functional to receive data from sensors and to control equipment associated with the end effector (e.g., additive manufacturing applicators, sensors) and/or control a robotic actuator.

While specific processes and/or systems for additive manufacturing end-effector assemblies configured to mount to robotic actuators are described above, any of a variety of processes and/or systems can be utilized for additive manufacturing end-effector assemblies configured to mount to robotic actuators as appropriate to the requirements of specific applications. Notably, all references to wire arc additive manufacturing in this application are provided as an example and should not be construed as limiting. The inventive concepts in this application are applicable to any Directed Energy Deposition (DED) 3D printing process that uses wire feedstock. Relevant energy sources are plasma, arc, laser, and others. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to additive manufacturing end-effector assemblies configured to mount to robotic actuators, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

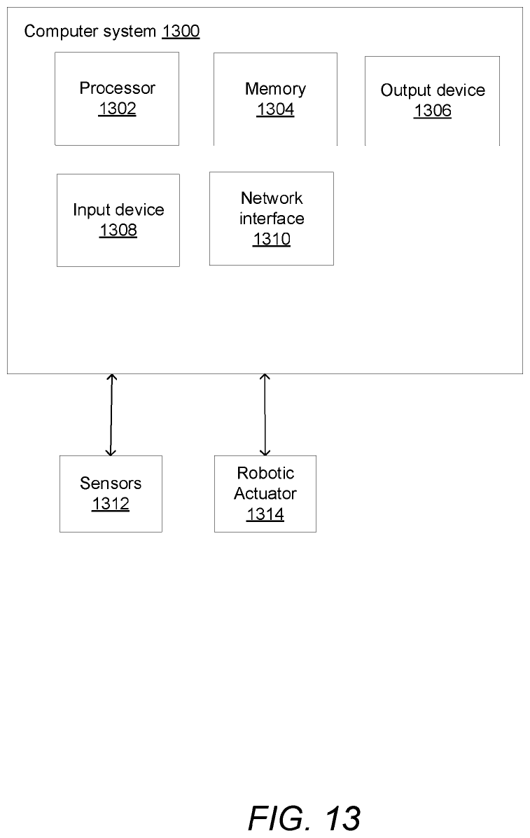

In several embodiments, a computer system can be used to store and execute instructions. An example computer system is conceptually illustrated in FIG. 13. The computer system 1300 can include a processor 1302, a memory 1304, an output device 1306, an input device 1308 and a network interface 1310. The computer system 1300 can receive and/or send data from/to sensor 1312, users and/or other sources. The computer system 1300 can receive and/or send data from/to robotic actuator 1314. In several embodiments, the robotic actuator can be configured to actuate an additive manufacturing end effector assembly. Computer systems can be configured to command robotic actuators. Computer systems can be configured to run executable code. Executable code can be stored in memory.

While specific processes and/or systems for computer system are described above, any of a variety of processes and/or systems can be utilized as a computer system as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a computer system, the techniques disclosed herein may be used in any type of additive manufacturing system. The techniques disclosed herein may be used within any of the additive manufacturing modular end effector assemblies, modular interfaces, cold-wire actuators, torch configurations, localized fume extraction systems, arc protection systems, and/or Restart automation systems as described herein.

### Automated Contact Tip to Work Distance Correction (Auto CTWD)

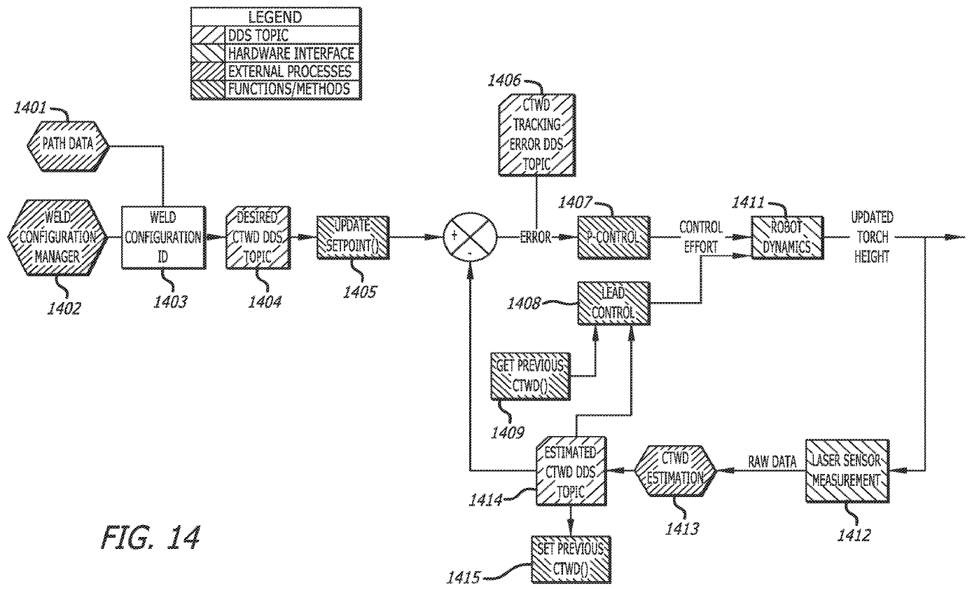

In several embodiments, an automated contact tip to work distance correction (auto CTWD) can include a process for automatically maintaining a certain distance from a contact tip to the top of a printed part. CTWD measurements can be obtained from laser scanners, such as one or more line lasers. In a number of embodiments, CTWD measurements can be obtained from cameras. Laser-based measurements for auto CTWD can have a number of advantages over camera-based methods. For example, an auto CTWD process based on laser measurements can be robust to different lighting conditions, more functional during weaving, can achieve a higher update frequency, can enable flexible measurement and/or control parameters, and can avoid and/or reduce steady-state errors and/or oscillatory responses. In several embodiments, the Auto CTWD process can be configured as a closed control loop. An example AUTO CTWD process configured as a closed loop is conceptually illustrated in the controller block diagram of FIG. 14.

FIG. 14 conceptually illustrates a controller block diagram of an automated contact tip to work piece correction process. As shown in FIG. 14, path data 1401 for a print can be obtained. A weld configuration identifier (ID) 1403 can be retrieved from a weld configuration manager 1402, along with any other relevant parameters. The weld configuration manager can be configured to store and display up-to-date versions of weld configurations. The weld configuration ID 1403 can include weld configurations from the weld configuration manager 1402 that can be used for path planning, in conjunction with path data 1401. The path data 1401, weld configuration ID 1403, and/or other relevant parameters from weld configuration manager 1402 can be used to determine a desired contact to work distance (CTWD) 1404. Based on the desired CTWD 1404, an update setpoint command 1405 can be executed to update the current setpoint for the closed control loop. In various embodiments, an update setpoint command can include a function call.

In various embodiments, a proportional control (P-control) 1407 can be executed to apply a correctional command to a robot dynamics hardware interface 1411. The correctional command can be determined based on an error 1406. The error 1406 can be calculated as the difference between the desired CTWD 1404 and actual/estimated CTWD 1414. The P-control 1407 and lead control 1408 can command the robot dynamics hardware interface 1411 to update the print/weld torch height. One or more laser sensor measurements 1412 can then be performed. In several embodiments, laser sensor measurements can include 70 Hz raw data measurements. In accordance with embodiments of the invention, laser sensor measurements can be obtained from a line laser, such as a Keyence laser scanner. From the laser measurements 1412, a CTWD estimate calculation 1413 can be performed to obtain the CTWD estimate 1414. The current setpoint can be recorded as a previous CTWD 1415. The lead control 1408 can obtain the CTWD estimate 1414 and can obtain the previous CTWD 1415 using a get previous CTWD function call 1409. In numerous embodiments, the lead control can be the main program controlling the position of the additive manufacturing robotic system, keeping the robot on the path required to perform the print.

### Dual Plasma WAAM Nozzle Assembly

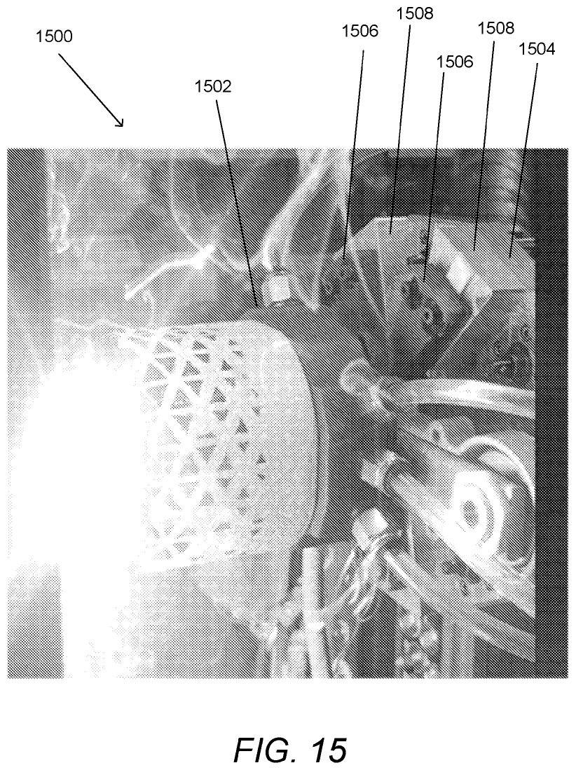

An example WAAM nozzle assembly mounted to an end effector assembly is conceptually illustrated in FIG. 15. A dual plasma assembly 1500 can include a WAAM nozzle 1502 mounted to an interface 1504. The WAAM nozzle 1502 can include at least one connector 1506. The connectors 1506 can couple to one or more connection points 1508, the connection points 1508 are attached to the interface 1504.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

1-20. (canceled)

21. A device configured for additive manufacturing, the device comprising:
a robotic actuator;
an end effector assembly mounted to the robotic actuator; and
a control assembly;
wherein the end effector assembly comprises:
an additive manufacturing applicator comprising an applicator endpoint; and
one or more sensors positioned to generate data from observations of a part undergoing additive manufacturing; and
wherein the device is configured to perform an automated restart to compensate for a geometric deviation between the part undergoing additive manufacturing and a digital model from sensor-generated data following a stop in the additive manufacturing process, by adjusting a position of the applicator endpoint relative to the part.

22. The device of claim 21, wherein the additive manufacturing applicator comprises a hot wire torch.

23. The device of claim 21, wherein the one or more sensors include at least one sensor selected from the group consisting of:
welding cameras, infrared cameras, visible light cameras, and laser sensors.

24. The device of claim 21, wherein the control assembly is configured to initiate the automated restart based on data generated by the one or more sensors.

25. The device of claim 24, wherein the automated restart is performed in response to a detection by the one or more sensors of the geometrical deviation of the part exceeding a threshold.

26. The device of claim 25, wherein the threshold is determined based on a spatial profile of the part.

27. The device of claim 21, wherein the device is further configured to dynamically compensate for a thermally induced dimensional change of the part during additive manufacturing.

28. The device of claim 24, wherein the control assembly converts sensor data from the one or more sensors into a format for at least one restart alignment command.

29. The device of claim 21, wherein the end effector assembly further comprises a modular interface comprising a set of connection points arranged circumferentially about a modular interface central axis, the additive manufacturing applicator is coupled to the modular interface, and the one or more sensors is fixedly attached via the set of connection points to the modular interface.

30. The device of claim 21, wherein the automated restart is performed automatically at predetermined intervals during the additive manufacturing process.

31. The device of claim 21, wherein the control assembly comprises:
memory; and
a processor, the processor configured to:
receive sensor data generated by the one or more sensors;
generate a spatial profile of the part based on a sensor data;
determine a restart offset from the spatial profile; and
command the robotic actuator to reposition the applicator endpoint based on the restart offset.

32. The device of claim 31, wherein the control assembly is configured to filter the sensor data to remove at least one outlier prior to determining the restart offset.

33. The device of claim 31, wherein the restart offset determination is continuously updated from the sensor data throughout the additive manufacturing process.

34. A method of performing an additive manufacturing process, comprising:
performing a build operation using a robotic actuator to additively build a part;
stopping the build operation at a stop coordinate based on sensor data and a spatial profile of the part;
determining a restart offset coordinate from the spatial profile, wherein generating the spatial profile comprises:
receiving a raw spatial profile from one or more sensors;
converting the raw spatial profile into units configured for the additive manufacturing process;
filtering the spatial profile to eliminate outliers;
interpolating the spatial profile to obtain a profile estimate;
applying an offset based on the profile estimate;
transposing the spatial profile; and
reducing the spatial profile; and
restarting the build operation at a restart coordinate based on the stop coordinate and the restart offset coordinate.

35. The method of claim 34, wherein filtering the spatial profile comprises identifying and eliminating at least one anomalous data point.

36. The method of claim 34, wherein the offset compensates for a thermal expansion of the part during additive manufacturing.

37. The method of claim 34, wherein reducing the spatial profile comprises optimizing at least one data point for a movement of the robotic actuator.

38. The method of claim 34, wherein determining the restart offset coordinate is performed dynamically throughout the additive manufacturing process.

39. The method of claim 34, further comprising continuously updating the spatial profile with sensor data during the additive manufacturing process.

40. The device of claim 21, wherein the digital model comprises a thermal data simulation.
